(19) United States
(12) Patent Application Publication
(10) Pub. No.: US 2014/0281842 A1
(43) Pub. Date: Sep. 18, 2014

(54) Non-Volatile Cells Having a Non-Power-of-Two Number of States

(71) Applicant: FUSION-IO, INC., Salt Lake City, UT (US)

(72) Inventors: Robert Wood, Niwot, CO (US); David Flynn, Sandy, UT (US); Jeremy Fillingim, Salt Lake City, UT (US); Warner Losh, Broomfield, CO (US)

(73) Assignee: FUSION-IO, INC., Salt Lake City, UT (US)

(21) Appl. No.: 13/831,047

(22) Filed: Mar. 14, 2013

(51) Int. Cl. G06F 12/02; G06F 11/00

(52) U.S. Cl. CPC G06F 12/0246; G06F 11/006
USPC 714/799; 711/103

(57) ABSTRACT

An apparatus, system, and method are disclosed for accessing non-volatile cells. An interface module is configured to receive data for storage on a non-volatile memory medium. The non-volatile memory medium includes an array of cells, and each cell encodes a non-power-of-two number of states, or abodes per cell. A base conversion module is configured to convert the data from a binary representation to a representation in a non-binary base. The non-binary base uses a number of unique digits equal to the non-power-of-two number of abodes per cell. A write module is configured to store the converted data to the array of cells.

### TECHNICAL FIELD

The present disclosure, in various embodiments, relates to data storage and more particularly relates to accessing non-volatile data cells having a non-power-of-two number of states per cell.

### BACKGROUND

Several types of data storage devices, such as Flash memory, store data in arrays of cells. A physical property of each cell, such as a stored charge, material phase, electrical resistance, magnetization, or the like, is alterable to encode data. The range of possible values for the physical property is divided into discrete states, so that each state encodes a possible data value. For example, a cell with two states may encode a “0” or a “1,” corresponding to one binary digit, or bit, of information.

Higher storage densities may be achieved by dividing the range of possible values for each cell into more than two states. In general, doubling the number of states increases a cell's capacity by one bit, so that using a number of states equal to a power of two allows a cell to encode a whole number of bits. Encoding a whole number of bits is convenient for storing binary data. For example, a cell with four states may encode two bits of information, and a cell with eight states may encode three bits of information.

However, using a power of two as the number of states per cell introduces constraints. Increasing the capacity of a cell by doubling the number of states may involve decreasing the size of each state by approximately one half. Such a significant decrease in the size of each state may, in turn, significantly increase the probability of an error occurring due to a stored value for the cell drifting from one state to an adjacent state. For example, increasing the capacity of a cell by doubling the number of states from four to eight may decrease the reliability of the cell below desirable levels.

### SUMMARY

A method is presented for accessing non-volatile cells. In one embodiment, the method includes receiving data for storage on a non-volatile recording medium. In a certain embodiment, the non-volatile recording medium includes an array of cells. In a further embodiment, each cell has or encodes a number of states per cell other than a power of two. In some embodiments, the method includes converting the data from a binary representation to a non-binary representation corresponding to the number of states per cell. In certain embodiments, the method includes storing the converted data to the array of cells.

An apparatus is presented for accessing non-volatile cells. In one embodiment, an interface module is configured to receive data for storage on a non-volatile memory medium. In a certain embodiment, the non-volatile memory medium includes an array of cells. In a further embodiment, each cell has or encodes a number of abodes per cell with a non-binary alignment. In some embodiments, a base conversion module is configured to convert the data from a binary representation to a representation in a non-binary base. In further embodiments, the non-binary base uses a number of unique digits equal to the non-binary aligned number of abodes per cell. In certain embodiments, a write module is configured to store the converted data to the array of cells.

Another apparatus is presented for accessing non-volatile cells. In one embodiment, the apparatus includes means for receiving data for storage on a non-volatile storage medium. In a certain embodiment, the non-volatile storage medium includes an array of cells. In a further embodiment, each cell has or encodes a non-power-of-two number of encoding states per cell. In some embodiments, the apparatus includes means for converting the data from a binary representation to a representation in a non-binary base, for storage by the non-volatile storage medium. In further embodiments, the non-binary base uses a number of unique digits equal to the number of encoding states per cell. In certain embodiments, the apparatus includes means for dynamically adjusting the number of states per cell over time.

A system is presented for accessing non-volatile cells. In one embodiment, a non-volatile recording device includes a non-volatile recording medium. In a further embodiment, the non-volatile recording medium includes an array of cells. In a certain embodiment, each cell has or encodes a non-power-of-two number of states per cell. In a further embodiment, the non-volatile recording device is in communication with a host device over a communications bus. In some embodiments, a write pipeline includes an interface module, a base conversion module, and a write module. In one embodiment the interface module is configured to receive data for storage on the non-volatile recording medium. In a certain embodiment, the base conversion module is configured to convert the data from a binary representation to a representation in a non-base-two base. In some embodiments, the non-base-two base uses a number of unique digits equal to the non-power-of-two number of states per cell. In a further embodiment, the write module is configured to store the converted data to the array of cells.

A computer program product is presented to perform operations for accessing non-volatile cells. In certain embodiments, the computer program product includes a computer readable storage medium storing computer usable program code executable to perform the operations of the computer program product. In one embodiment, the operations include reading non-binary data from a non-volatile memory medium. In a certain embodiment, the non-volatile memory medium includes an array of cells. In a further embodiment, each cell encodes a number of abodes per cell other than a power of two. In some embodiments, the non-binary data is encoded in a non-binary base. In further embodiments, the non-binary base uses a number of unique digits equal to the number of abodes per cell. In some embodiments, the operations include translating the non-binary data to binary data. In further embodiments, the operations include returning the binary data to a host device and/or a storage controller for the non-volatile memory medium.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1A is a schematic block diagram of one embodiment of a non-volatile memory system comprising a cell access module;

FIG. 1B is a schematic block diagram of another embodiment of a non-volatile memory system comprising a cell access module;

FIG. 2 is a schematic block diagram of another embodiment of a non-volatile memory system;

FIG. 3 is a schematic block diagram illustrating one embodiment of a cell access module;

FIG. 4 is a schematic block diagram illustrating another embodiment of a cell access module;

FIG. 5 is a schematic block diagram illustrating a further embodiment of a cell access module;

FIG. 6 illustrates non-volatile cells in one embodiment of a programming sequence;

FIG. 7 illustrates non-volatile cells in another embodiment of a programming sequence;

FIG. 8 is a schematic flow chart diagram illustrating one embodiment of a method for accessing non-volatile cells; and

FIG. 9 is a schematic flow chart diagram illustrating another embodiment of a method for accessing non-volatile cells.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

According to various embodiments, a non-volatile memory controller manages one or more non-volatile memory devices. The non-volatile memory device(s) may comprise memory or storage devices, such as solid-state storage device(s), that are arranged and/or partitioned into a plurality of addressable media storage locations. As used herein, a media storage location refers to any physical unit of memory (e.g., any quantity of physical storage media on a non-volatile memory device). Memory units may include, but are not limited to: pages, memory divisions, erase blocks, sectors, blocks, collections or sets of physical storage locations (e.g., logical pages, logical erase blocks, described below), or the like.

The non-volatile memory controller may comprise a storage management layer (“SML”), which may present a logical address space to one or more storage clients. One example of an SML is the Virtual Storage Layer® of Fusion-io, Inc. of Salt Lake City, Utah. Alternatively, each non-volatile memory device may comprise a non-volatile memory media controller, which may present a logical address space to the storage clients. As used herein, a logical address space refers to a logical representation of memory resources. The logical address space may comprise a plurality (e.g., range) of logical addresses. As used herein, a logical address refers to any identifier for referencing a memory resource (e.g., data), including, but not limited to: a logical block address (“LBA”), cylinder/head/sector (“CHS”) address, a file name, an object identifier, an inode, a Universally Unique Identifier (“UUID”), a Globally Unique Identifier (“GUID”), a hash code, a signature, an index entry, a range, an extent, or the like.

The SML may maintain metadata, such as a forward index, to map logical addresses of the logical address space to media storage locations on the non-volatile memory device(s). The SML may provide for arbitrary, any-to-any mappings from logical addresses to physical storage resources. As used herein, an “any-to any” mapping may map any logical address to any physical storage resource. Accordingly, there may be no pre-defined and/or pre-set mappings between logical addresses and particular, media storage locations and/or media addresses. As used herein, a media address refers to an address of a memory resource that uniquely identifies one memory resource from another to a controller that manages a plurality of memory resources. By way of example, a media address includes, but is not limited to: the address of a media storage location, a physical memory unit, a collection of physical memory units (e.g., a logical memory unit), a portion of a memory unit (e.g., a logical memory unit address and offset, range, and/or extent), or the like. Accordingly, the SML may map logical addresses to physical data resources of any size and/or granularity, which may or may not correspond to the underlying data partitioning scheme of the non-volatile memory device(s). For example, in some embodiments, the non-volatile memory controller is configured to store data within logical memory units that are formed by logically combining a plurality of physical memory units, which may allow the non-volatile memory controller to support many different virtual memory unit sizes and/or granularities.

As used herein, a logical memory element refers to a set of two or more non-volatile memory elements that are or are capable of being managed in parallel (e.g., via an I/O and/or control bus). A logical memory element may comprise a plurality of logical memory units, such as logical pages, logical memory divisions (e.g., logical erase blocks), and so on. As used herein, a logical memory unit refers to a logical construct combining two or more physical memory units, each physical memory unit on a respective non-volatile memory element in the respective logical memory element (each non-volatile memory element being accessible in parallel). As used herein, a logical memory division refers to a set of two or more physical memory divisions, each physical memory division on a respective non-volatile memory element in the respective logical memory element.

The logical address space presented by the storage management layer may have a logical capacity, which may correspond to the number of available logical addresses in the logical address space and the size (or granularity) of the data referenced by the logical addresses. For example, the logical capacity of a logical address space comprising 2̂32 unique logical addresses, each referencing 2048 bytes (2 KiB) of data may be 2̂43 bytes. (As used herein, a kibibyte (KiB) refers to 1024 bytes). In some embodiments, the logical address space may be thinly provisioned. As used herein, a “thinly provisioned” logical address space refers to a logical address space having a logical capacity that exceeds the physical capacity of the underlying non-volatile memory device(s). For example, the storage management layer may present a 64-bit logical address space to the storage clients (e.g., a logical address space referenced by 64-bit logical addresses), which exceeds the physical capacity of the underlying non-volatile memory devices. The large logical address space may allow storage clients to allocate and/or reference contiguous ranges of logical addresses, while reducing the chance of naming conflicts. The storage management layer may leverage the any-to-any mappings between logical addresses and physical storage resources to manage the logical address space independently of the underlying physical storage devices. For example, the storage management layer may add and/or remove physical storage resources seamlessly, as needed, and without changing the logical addresses used by the storage clients.

The non-volatile memory controller may be configured to store data in a contextual format. As used herein, a contextual format refers to a self-describing data format in which persistent contextual metadata is stored with the data on the physical storage media. The persistent contextual metadata provides context for the data it is stored with. In certain embodiments, the persistent contextual metadata uniquely identifies the data that the persistent contextual metadata is stored with. For example, the persistent contextual metadata may uniquely identify a sector of data owned by a storage client from other sectors of data owned by the storage client. In a further embodiment, the persistent contextual metadata identifies an operation that is performed on the data. In a further embodiment, the persistent contextual metadata identifies a sequence of operations performed on the data. In a further embodiment, the persistent contextual metadata identifies security controls, a data type, or other attributes of the data. In a certain embodiment, the persistent contextual metadata identifies at least one of a plurality of aspects, including data type, a unique data identifier, an operation, and a sequence of operations performed on the data. The persistent contextual metadata may include, but is not limited to: a logical address of the data, an identifier of the data (e.g., a file name, object id, label, unique identifier, or the like), reference(s) to other data (e.g., an indicator that the data is associated with other data), a relative position or offset of the data with respect to other data (e.g., file offset, etc.), data size and/or range, and the like. The contextual data format may comprise a packet format comprising a data segment and one or more headers. Alternatively, a contextual data format may associate data with context information in other ways (e.g., in a dedicated index on the non-volatile memory media, a memory division index, or the like).

In some embodiments, the contextual data format may allow data context to be determined (and/or reconstructed) based upon the contents of the non-volatile memory media, and independently of other metadata, such as the arbitrary, any-to-any mappings discussed above. Since the media location of data is independent of the logical address of the data, it may be inefficient (or impossible) to determine the context of data based solely upon the media location or media address of the data. Storing data in a contextual format on the non-volatile memory media may allow data context to be determined without reference to other metadata. For example, the contextual data format may allow the metadata to be reconstructed based only upon the contents of the non-volatile memory media (e.g., reconstruct the any-to-any mappings between logical addresses and media locations).

In some embodiments, the non-volatile memory controller may be configured to store data on one or more asymmetric, write-once media, such as solid-state storage media. As used herein, a “write once” storage medium refers to a storage medium that is reinitialized (e.g., erased) each time new data is written or programmed thereon. As used herein, an “asymmetric” storage medium refers to a storage medium having different latencies for different storage operations. Many types of solid-state storage media are asymmetric; for example, a read operation may be much faster than a write/program operation, and a write/program operation may be much faster than an erase operation (e.g., reading the media may be hundreds of times faster than erasing, and tens of times faster than programming the media). The memory media may be partitioned into memory divisions that can be erased as a group (e.g., erase blocks) in order to, inter alia, account for the asymmetric properties of the media. As such, modifying a single data segment in-place may require erasing the entire erase block comprising the data, and rewriting the modified data to the erase block, along with the original, unchanged data. This may result in inefficient “write amplification,” which may excessively wear the media. Therefore, in some embodiments, the non-volatile memory controller may be configured to write data out-of-place. As used herein, writing data “out-of-place” refers to writing data to different media storage location(s) rather than overwriting the data “in-place” (e.g., overwriting the original physical location of the data). Modifying data out-of-place may avoid write amplification, since existing, valid data on the erase block with the data to be modified need not be erased and recopied. Moreover, writing data out-of-place may remove erasure from the latency path of many storage operations (the erasure latency is no longer part of the critical path of a write operation).

The non-volatile memory controller may comprise one or more processes that operate outside of the regular path for servicing of storage operations (the “path” for performing a storage operation and/or servicing a storage request). As used herein, the “path for servicing a storage request” or “path for servicing a storage operation” (also referred to as the “critical path”) refers to a series of processing operations needed to service the storage operation or request, such as a read, write, modify, or the like. The path for servicing a storage request may comprise receiving the request from a storage client, identifying the logical addresses of the request, performing one or more storage operations on non-volatile memory media, and returning a result, such as acknowledgement or data. Processes that occur outside of the path for servicing storage requests may include, but are not limited to: a groomer, de-duplication, and so on. These processes may be implemented autonomously and in the background, so that they do not interfere with or impact the performance of other storage operations and/or requests. Accordingly, these processes may operate independent of servicing storage requests.

In some embodiments, the non-volatile memory controller comprises a groomer, which is configured to reclaim memory divisions (e.g., erase blocks) for reuse. The write out-of-place paradigm implemented by the non-volatile memory controller may result in obsolete or invalid data remaining on the non-volatile memory media. For example, overwriting data X with data Y may result in storing Y on a new memory division (rather than overwriting X in place), and updating the any-to-any mappings of the metadata to identify Y as the valid, up-to-date version of the data. The obsolete version of the data X may be marked as invalid, but may not be immediately removed (e.g., erased), since, as discussed above, erasing X may involve erasing an entire memory division, which is a time-consuming operation and may result in write amplification. Similarly, data that is no longer is use (e.g., deleted or trimmed data) may not be immediately removed. The non-volatile memory media may accumulate a significant amount of invalid data. A groomer process may operate outside of the critical path for servicing storage operations. The groomer process may reclaim memory divisions so that they can be reused for other storage operations. As used herein, reclaiming a memory division refers to erasing the memory division so that new data may be stored/programmed thereon. Reclaiming a memory division may comprise relocating valid data on the memory division to a new location. The groomer may identify memory divisions for reclamation based upon one or more factors, which may include, but are not limited to: the amount of invalid data in the memory division, the amount of valid data in the memory division, wear on the memory division (e.g., number of erase cycles), time since the memory division was programmed or refreshed, and so on.

The non-volatile memory controller may be further configured to store data in a log format. As described above, a log format refers to a data format that defines an ordered sequence of storage operations performed on a non-volatile memory media. In some embodiments, the log format comprises storing data in a pre-determined sequence of media addresses of the non-volatile memory media (e.g., within sequential pages and/or erase blocks of the media). The log format may further comprise associating data (e.g., each packet or data segment) with respective sequence indicators. The sequence indicators may be applied to data individually (e.g., applied to each data packet) and/or to data groupings (e.g., packets stored sequentially on a memory division, such as an erase block). In some embodiments, sequence indicators may be applied to memory divisions when the memory divisions are reclaimed (e.g., erased), as described above, and/or when the memory divisions are first used to store data.

In some embodiments the log format may comprise storing data in an “append only” paradigm. The non-volatile memory controller may maintain a current append point at a media address of the non-volatile memory device. The append point may be a current memory division and/or offset within a memory division. Data may then be sequentially appended from the append point. The sequential ordering of the data, therefore, may be determined based upon the sequence indicator of the memory division of the data in combination with the sequence of the data within the memory division. Upon reaching the end of a memory division, the non-volatile memory controller may identify the “next” available memory division (the next memory division that is initialized and ready to store data). The groomer may reclaim memory divisions comprising invalid, stale, and/or deleted data, to ensure that data may continue to be appended to the media log.

The log format described herein may allow valid data to be distinguished from invalid data based upon the contents of the non-volatile memory media, and independently of other metadata. As discussed above, invalid data may not be removed from the non-volatile memory media until the memory division comprising the data is reclaimed. Therefore, multiple “versions” of data having the same context may exist on the non-volatile memory media (e.g., multiple versions of data having the same logical addresses). The sequence indicators associated with the data may be used to distinguish invalid versions of data from the current, up-to-date version of the data; the data that is the most recent in the log is the current version, and previous versions may be identified as invalid.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description.

FIG. 1A is a block diagram of one embodiment of a system 100 comprising a cell access module 150. The cell access module 150 may be part of and/or in communication with a storage management layer (SML) 130. The SML 130 may operate on a non-volatile memory system 102 of a computing device 110, which may comprise a processor 111, volatile memory 112, and a communication interface 113. The processor 111 may comprise one or more central processing units, one or more general-purpose processors, one or more application-specific processors, one or more virtual processors (e.g., the computing device 110 may be a virtual machine operating within a host), one or more processor cores, or the like. The communication interface 113 may comprise one or more network interfaces configured to communicatively couple the computing device 110 (and/or non-volatile memory controller 124) to a communication network, such as an Internet Protocol network, a Storage Area Network, or the like.

The computing device 110 may further comprise a non-transitory, computer readable storage media 114. The computer readable storage media 114 may comprise executable instructions configured to cause the computing device 110 (e.g., processor 111) to perform steps of one or more of the methods disclosed herein. Alternatively, or in addition, the storage management layer 130 and/or one or more modules thereof may be embodied as one or more computer readable instructions stored on the non-transitory storage media 114.

The storage management layer 130 may be configured to provide storage services to one or more storage clients 116. The storage clients 116 may include local storage clients 116 operating on the computing device 110 and/or remote, storage clients 116 accessible via the network (and network interface 113). The storage clients 116 may include, but are not limited to: operating systems, file systems, database applications, server applications, kernel-level processes, user-level processes, applications, and the like.

The storage management layer 130 comprises and/or is communicatively coupled to one or more non-volatile memory devices 120 Å-N. The non-volatile memory devices 120A-N may include different types of non-volatile memory devices including, but not limited to: solid-state storage devices, hard drives, SAN storage resources, or the like. The non-volatile memory devices 120A-N may comprise respective non-volatile memory media controllers 126A-N and non-volatile memory media 122A-N. As illustrated in FIG. 1B, The SML 130 may provide access to the non-volatile memory devices 120A-N via a traditional block I/O interface 131. Additionally, the SML 130 may provide access to enhanced functionality (large, virtual address space) through the SML interface 132. The metadata 135 may be used to manage and/or track storage operations performed through any of the Block I/O interface 131, SML interface 132, cache interface 133, or other, related interfaces.

The cache interface 133 may expose cache-specific features accessible via the storage management layer 130. Also, in some embodiments, the SML interface 132 presented to the storage clients 116 provides access to data transformations implemented by the non-volatile memory devices 120A-N and/or the non-volatile memory media controllers 126A-N.

The SML 130 may provide storage services through one or more interfaces, which may include, but are not limited to: a block I/O interface, an extended storage management layer interface, a cache interface, and the like. The SML 130 may present a logical address space 134 to the storage clients 116 through one or more interfaces. As discussed above, the logical address space 134 may comprise a plurality of logical addresses, each corresponding to respective media locations on one or more of the non-volatile memory devices 120A-N. The SML 130 may maintain metadata 135 comprising any-to-any mappings between logical addresses and media locations, as described above.

The SML 130 may further comprise a log storage module 137 that is configured to store data in a contextual, log format. The contextual, log data format may comprise associating data with persistent contextual metadata, such as the logical address of the data, or the like. The contextual, log format may further comprise associating data with respective sequence identifiers on the non-volatile memory media 122A-N, which define an ordered sequence of storage operations performed on the non-volatile memory devices 120A-N, as described above.

The SML 130 may further comprise a non-volatile memory device interface 139 configured to transfer data, commands, and/or queries to the non-volatile memory devices 120A-N over a bus 125, which may include, but is not limited to: a peripheral component interconnect express (“PCI Express” or “PCIe”) bus, a serial Advanced Technology Attachment (“ATA”) bus, a parallel ATA bus, a small computer system interface (“SCSI”), FireWire, Fibre Channel, a Universal Serial Bus (“USB”), a PCIe Advanced Switching (“PCIe-AS”) bus, a network, Infiniband, SCSI RDMA, or the like. The non-volatile memory device interface 139 may communicate with the non-volatile memory devices 120A-N using input-output control (“IO-CTL”) command(s), IO-CTL command extension(s), remote direct memory access, or the like.

The non-volatile memory system 102, in the depicted embodiment, includes a cell access module 150 for accessing cells of non-volatile memory media 122 encoding a non-power-of-two number of states per cell. The cell access module 150, in one embodiment, is configured to receive data for storage on non-volatile memory media 122, where the non-volatile memory media 122 includes an array of cells, and each cell encodes a number of states per cell other than a power of two, with a non-binary alignment, or the like. In certain embodiments, the cell access module 150 is configured to convert the data from a binary representation to a representation in a non-binary base. In one embodiment the non-binary base uses a number of unique digits equal to the number of states per cell. In a further embodiment, the cell access module 150 is configured to store the converted data to the array of cells. Converting binary data to a non-binary base allows a user or manufacturer to affect the storage capacity or error rate of non-volatile memory media 122 by configuring the number of states per cell, and avoids the constraints associated with changing cell capacity in binary aligned one bit increments, by doubling or halving the number of states per cell.

In one embodiment, the cell access module 150 may comprise executable software code, such as a device driver, SML 130, or the like, stored on the computer readable storage media 114 for execution on the processor 111. In another embodiment the cell access module 150 may comprise logic hardware of one or more of the non-volatile memory devices 120A-N, such as a non-volatile memory media controller 126A-N, a non-volatile memory controller 124, a device controller, a field-programmable gate array (“FPGA”) or other programmable logic, firmware for an FPGA or other programmable logic, microcode for execution on a microcontroller, an application-specific integrated circuit (“ASIC”), or the like. In a further embodiment, the cell access module 150 may include a combination of both executable software code and logic hardware.

In one embodiment, the cell access module 150 is configured to receive storage requests from the SML 130 via a bus 125 or the like. The cell access module 150 may be further configured to transfer data to/from the SML 130 and/or storage clients 116 via the bus 125. Accordingly, the cell access module 150, in some embodiments, may comprise and/or be in communication with one or more direct memory access (“DMA”) modules, remote DMA modules, bus controllers, bridges, buffers, and so on to facilitate the transfer of storage requests and associated data. In another embodiment, the cell access module 150 may receive storage requests as an API call from a storage client 116, as an IO-CTL command, or the like. The cell access module 150 is described in greater detail below with regard to FIGS. 3 and 4.

FIG. 1B is a block diagram of another embodiment of a system 101 comprising a cell access module 150. As described above, the cell access module 150 may be part of and/or in communication with a storage management layer 130. The SML 130 may operate on a non-volatile memory system 102 of a computing device 110, which, as discussed above, may comprise a processor 111, volatile memory 112, communication interface 113, and non-transitory, computer readable storage media 114. The communication interface 113 may comprise one or more network interfaces configured to communicatively couple the computing device 110 (and/or non-volatile memory controller 124) to a network 115 and/or to one or more remote, network-accessible storage clients 116.

The computing device 110 may comprise a non-volatile memory controller 124 that is configured to provide storage services to the storage clients 116. The storage clients 116 may include local storage clients 116 operating on the computing device 110 and/or remote, storage clients 116 accessible via the network 115 (and network interface 113). The non-volatile memory controller 124 comprises one or more non-volatile memory devices 120. Although FIG. 1B depicts a single non-volatile memory device 120, the disclosure is not limited in this regard and could be adapted to incorporate any number of non-volatile memory devices 120.

The non-volatile memory device 120 may comprise non-volatile memory media 122, which may include but is not limited to: NAND flash memory, NOR flash memory, nano random access memory (“nano RAM or NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM or PCM”), magnetic storage media (e.g., hard disk, tape), optical storage media, or the like. While the non-volatile memory media 122 is referred to herein as “memory media,” in various embodiments, the non-volatile memory media 122 may more generally comprise a non-volatile recording media capable of recording data, which may be referred to as a non-volatile memory media, a non-volatile storage media, or the like. Further, the non-volatile memory device 120, in various embodiments, may comprise a non-volatile recording device, a non-volatile memory device, a non-volatile storage device, or the like.

The non-volatile memory media 122 may comprise one or more non-volatile memory elements 123, which may include, but are not limited to: chips, packages, planes, die, and the like. A non-volatile memory media controller 126 may be configured to manage storage operations on the non-volatile memory media 122, and may comprise one or more processors, programmable processors (e.g., field-programmable gate arrays), or the like. In some embodiments, the non-volatile memory media controller 126 is configured to store data on (and read data from) the non-volatile memory media 122 in the contextual, log format described above, and to transfer data to/from the non-volatile memory device 120, and so on.

The non-volatile memory media controller 126 may be communicatively coupled to the non-volatile memory media 122 by way of a bus 127. The bus 127 may comprise an I/O bus for communicating data to/from the non-volatile memory elements 123. The bus 127 may further comprise a control bus for communicating addressing and other command and control information to the non-volatile memory elements 123. In some embodiments, the bus 127 may communicatively couple the non-volatile memory elements 123 to the non-volatile memory media controller 126 in parallel. This parallel access may allow the non-volatile memory elements 123 to be managed as a group, forming a logical memory element 129. As discussed above, the logical memory element may be partitioned into respective logical memory units (e.g., logical pages) and/or logical memory divisions (e.g., logical erase blocks). The logical memory units may be formed by logically combining physical memory units of each of the non-volatile memory elements. For example, if the non-volatile memory media 122 comprises twenty-five (25) non-volatile memory elements, each logical memory unit may comprise twenty-five (25) pages (a page of each element of non-volatile memory media 122).

The non-volatile memory controller 124 may comprise a SML 130 and the non-volatile memory media controller 126. The SML 130 may provide storage services to the storage clients 116 via one or more interfaces 131, 132, and/or 133. In some embodiments, the SML 130 provides a block-device I/O interface 131 through which storage clients 116 perform block-level I/O operations. Alternatively, or in addition, the SML 130 may provide a storage management layer (SML) interface 132, which may provide other storage services to the storage clients 116. In some embodiments, the SML interface 132 may comprise extensions to the block device interface 131 (e.g., storage clients 116 may access the SML interface 132 through extensions to the block device interface 131). Alternatively, or in addition, the SML interface 132 may be provided as a separate API, service, and/or library. The SML 130 may be further configured to provide a cache interface 133 for caching data using the non-volatile memory system 102.

As described above, the SML 130 may present a logical address space 134 to the storage clients 116 (through the interfaces 131, 132, and/or 133). The SML 130 may maintain metadata 135 comprising any-to-any mappings between logical addresses in the logical address space 134 and media locations on the non-volatile memory device 120. The metadata 135 may comprise a logical-to-physical mapping structure with entries that map logical addresses in the logical address space 134 and media locations on the non-volatile memory device 120. The logical-to-physical mapping structure of the metadata 135, in one embodiment, is sparsely populated, with entries for logical addresses for which the non-volatile memory device 120 stores data and with no entries for logical addresses for which the non-volatile memory device 120 does not currently store data. The metadata 135, in certain embodiments, tracks data at a block level, with the SML 130 managing data as blocks.

The non-volatile memory system 102 may further comprise a log storage module 137, which, as described above, may be configured to store data on the non-volatile memory device 120 in a contextual, log format. The contextual, log data format may comprise associating data with a logical address on the non-volatile memory media 122. The contextual, log format may further comprise associating data with respective sequence identifiers on the non-volatile memory media 122, which define an ordered sequence of storage operations performed on the non-volatile memory media 122, as described above. The non-volatile memory controller 124 may further comprise a non-volatile memory device interface 139 that is configured to transfer data, commands, and/or queries to the non-volatile memory media controller 126 over a bus 125, as described above.

FIG. 2 depicts another embodiment of a non-volatile memory controller 124 configured to access cells of a non-volatile memory device 120. The non-volatile memory device 120 may comprise a non-volatile memory media controller 126 and non-volatile memory media 122. The non-volatile memory media 122 may comprise a plurality of non-volatile memory elements 123, which may be communicatively coupled to the non-volatile memory media controller 126 via a bus 127, as described above.

The non-volatile memory media controller 126 may comprise a write pipeline 240 that is configured to store data on the non-volatile memory media 122 in a contextual format in response to requests received via the cell access module 150. In one embodiment, the cell access module 150 may include at least a portion of the write pipeline 240. The requests may include and/or reference data to be stored on the non-volatile memory media 122, may include logical address(es) of the data, and so on. As described above, the contextual format may comprise storing a logical address of the data in association with the data on the non-volatile memory media 122. For example, the write pipeline 240 may be configured to format data into packets, and may include the logical address of the data in a packet header (or other packet field). The write pipeline 240 may be configured to buffer data for storage on the non-volatile memory media 122. In some embodiments, the write pipeline 240 may comprise one or more synchronization buffers to synchronize a clock domain of the non-volatile memory media controller 126 with a clock domain of the non-volatile memory media 122 (and/or bus 127).

The log storage module 248 may be configured to select media location(s) for the data and may provide addressing and/or control information to the non-volatile memory elements 123 via the bus 127. In some embodiments, the log storage module 248 is configured to store data sequentially in a log format within the non-volatile memory media. The log storage module 248 may be further configured to groom the non-volatile memory media, as described above. In certain embodiments the log storage module 248 is substantially similar to the log storage module 137 as described above. The log storage module 248 may be executed by the SML 130 and/or by the non-volatile memory media controller 126.

Upon writing data to the non-volatile memory media, the non-volatile memory media controller 126 may be configured to update metadata 135 (e.g., a forward index) to associate the logical address(es) of the data with the media address(es) of the data on the non-volatile memory media 122. In some embodiments, the metadata 135 may be maintained on the non-volatile memory media controller 126; for example, the metadata 135 may be stored on the non-volatile memory media 122, on a volatile memory (not shown), or the like. Alternatively, or in addition, the metadata 135 may be maintained within the SML 130 (e.g., on a volatile memory 112 of the computing device 110 of FIGS. 1A and 1B). In some embodiments, the metadata 135 may be maintained in a volatile memory by the SML 130, and may be periodically stored on the non-volatile memory media 122.

The non-volatile memory media controller 126 may further comprise a read pipeline 241 that is configured to read contextual data from the non-volatile memory media 122 in response to requests received via the cell access module 150. In one embodiment, the cell access module 150 may include at least a portion of the read pipeline 241. The requests may comprise a logical address of the requested data, a media address of the requested data, and so on. The read pipeline 241 may be configured to read data stored in a contextual format from the non-volatile memory media 122 and to provide the data to the SML 130 and/or a storage client 116. The read pipeline 241 may be configured to determine the media address of the data using a logical address of the data and the metadata 135. Alternatively, or in addition, the SML 130 may determine the media address of the data and may include the media address in the request. The log storage module 248 may provide the media address to the non-volatile memory elements 123, and the data may stream into the read pipeline 241 via a buffer. The read pipeline 241 may comprise one or more read synchronization buffers for clock domain synchronization, as described above.

The non-volatile memory media controller 126 may further comprise a multiplexer 249 that is configured to selectively route data and/or commands to/from the write pipeline 240 and the read pipeline 241. In some embodiments, non-volatile memory media controller 126 may be configured to read data while filling a buffer of the write pipeline 240 and/or may interleave one or more storage operations on one or more banks of non-volatile memory elements 123 (not shown).

FIG. 3 depicts one embodiment of a cell access module 150. The cell access module 150 may be substantially similar to the cell access module 150 described above with regard to FIGS. 1A, 1B, and 2. In general, as described above, the cell access module 150 converts data to a non-binary base for storage by non-volatile cells having a non-power-of-two number of states per cell, with a non-binary alignment, or the like. In the depicted embodiment, the cell access module 150 includes an interface module 302, a base conversion module 304, and a write module 306.

The interface module 302, in one embodiment, is configured to monitor, detect, or otherwise receive data for storage on non-volatile memory media 122. In various embodiments, a means for receiving data may include an interface module 302, a cell access module 150, a non-volatile memory controller 124, a non-volatile memory media controller 126, a device driver such as a SML 130, a block I/O interface 131, a SML interface 132, a cache interface 133, a communication interface 113, a processor 111, a write pipeline 240, a system bus 125, a storage bus 127, other logic hardware, and/or other executable code stored on a computer readable storage medium. Other embodiments may include similar or equivalent means for receiving data.

In one embodiment, the non-volatile memory device 120 may be in communication with a host device, such as a computing device 110, over a communications bus, such as the bus 125. In a certain embodiment, the non-volatile memory media 122 of the non-volatile memory device 120 includes one or more arrays of storage cells. An array of cells may include a byte, word, error correcting code (“ECC”) chunk, physical page, logical page, physical erase block, logical erase block, die, chip, plurality of dies or chips, or the like.

As used herein, a “cell” refers to the smallest physical unit of storage or memory of non-volatile memory media 122. In some embodiments, each cell has a physical and/or electrical property which may be altered to encode or otherwise store data. For example, in Flash memory, a cell may include a floating gate transistor, and the physical property used to encode data may be the charge stored on the floating gate, the threshold voltage Vₜ that is sufficient to make the transistor conduct when applied to the control gate, or the like. As another example, in phase change memory, a cell may be a region of chalcogenide glass, and the physical property used to encode data may be the degree of crystallization of the region, the electrical resistance of the cell, or the like. As described above with regard to the non-volatile memory media 122, many types of cells may store data of a non-volatile memory device 120 for use with the cell access module 150.

In one embodiment, the range of possible values for the data-encoding physical property of a cell is divided into discrete states or abodes, so that each state encodes a possible data value, or set of data values. In a further embodiment, the states of a cell may be separated by guard bands. As used herein, a “state,” “encoding state,” or “abode” refers to a sub-range of possible values for the data-encoding physical property of a cell, so that each state corresponds to a single data value, or set of data values. In a certain embodiment, an encoding maps states of a cell to data values. For example, in a cell with two states, the encoding may map the lower state to a binary “1” and the upper state to a binary “0,” so that the cell stores 1 bit of information. The non-volatile memory media 122 may store data using other encodings. In general, cells with more states can encode more information.

In one embodiment, each cell of an array of cells for the non-volatile memory media 122 encodes a number of states per cell other than a power of two. As used herein, a “power of two” refers to the number two raised to a positive integer power, so that powers of two include 2=2¹, 4=2², 8=2³, 16=2⁴, . . . , 128=2⁷, and the like. Thus, a non-power-of-two number of states refers to a number of states not aligned with 2ⁿ, and not traditionally used to encode a binary value (e.g., having a non-binary alignment). A non-binary alignment, as used herein, refers to storage cells with a number of states or abodes per cell that may not always store or encode a whole number of binary bits. For example, as described below, the base conversion module 304 may convert binary base 2 data to data of a different base, so that the original binary bits are not evenly distributed among storage cells but instead a single bit of information may span or cross storage cells. Using a non-binary alignment, and a number of states per cell other than a power of two, in certain embodiments, provides flexibility that allows a user or manufacturer of a non-volatile memory device 120 to select the number of states per cell in a way that balances storage capacity and error rates. However, utilizing cells with a non-power-of-two number of states or a non-binary alignment may also involve storing data in a non-binary format.

In one embodiment, the storage capacity of a cell may be measured in bits. If a cell encodes a number of states aligned with 2ⁿ, each cell has a storage capacity of n bits. For example, a cell encoding 8 states can store 3 bits of data, because 8=2³. In general, in various embodiments, the storage capacity of a cell, in bits, is the base 2 logarithm of the number of states, even if the cell encodes a number of states per cell other than a power of two. Thus, for example, a cell encoding 11 states has a storage capacity of approximately 3.46 bits. In some embodiments the storage capacity of a cell or group of cells may be used to store user data, metadata, or a combination of user data and metadata. In various embodiments, metadata may include error correcting code (ECC) data, parity data, packet headers, or the like. For example, in one embodiment, where each cell in a group of cells has a storage capacity that is a non-integer number of bits, the group of cells may use its aggregate storage capacity to store an amount of user data equivalent to a whole number of bits per cell. In one further embodiment, the remaining storage capacity may be unused. In another embodiment, the group of cells may store metadata or other filler data to use up the remaining aggregate storage capacity. For example, a group of 100 cells where each cell has a storage capacity of 3.46 bits each may store 300 bits of user data and 46 bits of metadata, such as ECC data, parity data, or the like.

In a certain embodiment, the base conversion module 304 is configured to convert the data received by the interface module 302 to a base corresponding to the number of states per cell. In various embodiments, a means for converting data may include a base conversion module 304, a cell access module 150, a non-volatile memory controller 124, a non-volatile memory media controller 126, a device driver such as a SML 130, a processor 111, a write pipeline 240, other logic hardware, and/or other executable code stored on a computer readable storage medium. Other embodiments may include similar or equivalent means for converting data. In one embodiment, the base conversion module 304 may convert the data from a binary representation to a representation in a non-binary base. In further embodiments, the non-binary base may represent data by using a number of unique digits equal to the number of states per cell.

As used herein, a “base” may refer to the number of unique digits (including the digit zero) that may be used in a numeric representation of data (e.g., the radix of a positional numeral system). For example, binary data is in base 2 because it uses two digits (“0” and “1”) to represent data. Similarly, hexadecimal data is in base 16 because it uses 16 digits (“0”-“9” and “A”-“F”) to represent data. In one embodiment, the base conversion module 304 may convert data to a base corresponding to the number of states per cell by using a number of unique digits equal to the number of states per cell, to represent the data. In a further embodiment, a base corresponding to the non-power-of-two number of states, or abodes, per cell may be a non-binary, or non-base-two base (e.g., a base other than base.2, base 4, base 8, base 16, or the like). For example, in a certain embodiment, if each cell of the non-volatile memory media 122 encodes five states, the base conversion module 304 may convert the data to base 5 for storage on the non-volatile memory media 122. Storing a base 5 digit allows a cell to store the informational equivalent of 2.32 bits. The base conversion module 304 may use an exponentiation process, a Homer's process, a digit normalization process, a repeated division process, a repeated subtraction process, an offset process, a division by descending powers process, a digit by digit process, or the like to convert data between different base encodings.

In one embodiment, the “target base” may refer to the base corresponding to the number of states per cell (e.g., a base with a number of unique digits equal to the number of states per cell), so that the base conversion module 304 converts data to the target base. In a certain embodiment, the data received by the interface module 302 may be binary data, and the base conversion module 304 may covert the binary data to a non-binary target base. In another embodiment, the data received by the interface module 302 may represented in a mixture of bases (e.g., binary-coded-decimal, or the like), or a non-binary base (e.g., hexadecimal, base 64, or base 3, or the like) other than the target base, and the base conversion module 304 may convert the data to the target base. In various embodiments, the base conversion module 304 may use various base conversion algorithms, or similar methods, to convert data to a target base. In light of this disclosure, many algorithms are clear which are suitable for use with a base conversion module 304.

In one embodiment, the array of cells is divided into discrete word units, so that each word unit includes a number of cells. In various embodiments, a word unit may include a word line of non-volatile memory media 122, an error correcting code (“ECC”) codeword (also known as a “chunk”), a packet, a physical or logical page, a physical or logical erase block, another number of cells, or the like. In further embodiments, each word unit has a storage capacity which may be measured in bits. In various embodiments, the storage capacity of a word unit is the sum of the storage capacities of each cell in the word unit. Thus, for example, if a word unit includes 7 cells, and each of the seven cells encodes 5 bits, the storage capacity of each cell is log₂(5)=2.32 bits, and the storage capacity of the word unit is 7*log₂(5)=16.25 bits. In certain embodiments, if each cell encodes a non-power-of-two number of states, then the storage capacity of each cell may be a non-integer number of bits, and the storage capacity of a word unit may also be a non-integer number of bits.

In certain embodiments, the base conversion module 304 may convert data to a non-binary base in units that fit within the storage capacity of the word units, even if the amount of data received by the interface module 302 does not evenly match the word unit storage capacity. For example, in one embodiment, the interface module 302 may receive the data in a binary stream format. In certain embodiments, a binary stream format, or binary data stream, may refer to a series of bits that encode data, numbers, values, information, or the like in binary form. For example, in various embodiments, a binary data stream may be a stream of individual bits received serially via bus 125, a stream of binary words received in parallel via bus 125 so that the words, in order, form a series of individual bits, or the like. In a further embodiment, the base conversion module 304 may separate the binary data stream from the interface module 302 into a plurality of individual binary numbers for conversion to the non-binary target base. In a certain embodiment, the base conversion module 304 may separate the binary data stream into binary numbers so that each binary number has a number of bits that is less than the word unit storage capacity for the array of cells. For example, in the embodiment above, where each word includes seven five-bit cells, so that the word unit storage capacity is 16.25 bits, the base conversion module 304 may separate the binary stream into 16-bit binary numbers, then convert each 16-bit binary number to a seven digit base-five number. In this example, the word unit does not utilize 0.25 bits (or 1.56% of its theoretical storage capacity), but stores 16 bits, a 14.3% increase over the 14-bit storage capacity of seven four-state cells. In light of this disclosure, it is clear that, in various embodiments, larger word units avoid under utilized storage capacity, but may also require increased time for base conversion of larger numbers.

In one embodiment, the interface module 302 may receive data in discrete units, such as packets, bytes, blocks, or the like, and the base conversion module 304 may convert the discrete units directly to the non-binary target base, if each discrete unit is a binary number with a number of bits less than the word unit storage capacity. In another embodiment, the base conversion module 304 may concatenate the discrete units into a binary stream, and then separate the binary stream into individual binary numbers as above, so that each binary number has a number of bits less than the word unit storage capacity.

In one embodiment, the non-volatile memory media 122 may include an array of cells, such as a byte, word, logical or physical page, logical or physical erase block, or the like, and the write module 306 may be configured to store the converted data from the base conversion module 304 to the array of cells. In various embodiments, a means for storing data may include a program sequence module 402, a stage module 404, an intermediate state module 406, and/or a skip verify module 408, as described below with regard to FIG. 4, a write module 306, a cell access module 150, a non-volatile memory controller 124, a non-volatile memory media controller 126, a write pipeline 240, other logic hardware, and/or other executable code stored on a computer readable storage medium. Other embodiments may include similar or equivalent means for storing data.

In one embodiment, the write module 306 may store the non-binary converted data from the base conversion module 304 by programming the cells of the array of cells into states according to an encoding, so that each state represents or encodes a digit of the target base. As an example, if the number of states per cell is five, than an encoding may map the five states L0, L1, L2, L3, and L4, to the digits “0,” “1,” “2,” “3,” and “4,” respectively, of the target base 5 representation. As another example, in another encoding for five-state cells, the encoding may map states L0, L1, L2, L3, and L4, to the digits “4,” “3,” “2,” “1,” and “0,” respectively. In light of this disclosure, it is clear that other encodings may also map between states of a cell and digits of a target base. Thus, in one embodiment, the write module 306 may store the digit “4” from the converted data by programming a cell into the L4 state (using the first encoding described above). In another embodiment, however, the write module 306 may store the digit “4” from the converted data by programming a cell into the L0 state (using the second encoding described above). Whatever encoding the write module 306 uses to store data, the write module 306 may, in various embodiments, program cells according to the encoding so that each cell of the array of cells stores a digit of the converted data.

In one embodiment, the write module 306 may cooperate with the non-volatile memory media controller 126 to program a cell by controlling voltages or other physical parameters that affect the data-encoding physical property of the cell. For example, in one embodiment, the non-volatile memory media 122 may include Flash memory cells where the stored charge on a floating gate encodes data, and the write module 306 and non-volatile memory media controller 126 may control programming pulses which apply a voltage to the cell to change the stored charge. In some embodiments, the write module 306 and non-volatile memory media controller 126 may determine whether to apply programming pulses, and how many programming pulses to apply, depending on the desired state of the cell. In further embodiments, the write module 306 and non-volatile memory media controller 126 may control parameters relating to the programming pulses, such as the initial voltage of a programming pulse, one or more step voltages for iterative programming pulses, the width (e.g., duration) of programming pulses, one or more verify threshold voltages for verifying that the cell is in the desired state, or the like, in an incremental step pulse programming model. In various embodiments, the non-volatile memory media 122 may include various types of cells, and the write module 306 may store converted data by programming the cells in a variety of ways.

FIG. 4 depicts another embodiment of a cell access module 150. The cell access module 150, in certain embodiments, may be substantially similar to the cell access module 150 described above with regard to FIGS. 1A, 1B, 2, and/or 3. In the depicted embodiment, the cell access module 150 includes an interface module 302, a base conversion module 304, and a write module 306, which may be configured substantially as described above with regard to FIG. 3. The cell access module 150, in the depicted embodiment, includes a read module 410, a translate module 412, a return module 414, an abode adjust module 416, and an error module 418. The write module 306, in the depicted embodiment, includes a program sequence module 402, a stage module 404, an intermediate state module 406, and a skip verify module 408. The depicted embodiment is intended as illustrative and not limiting; non-depicted embodiments of the cell access module 150 may include fewer modules than depicted or may include additional modules not described herein.

The write module 306 may use one or more sub-modules for storing the converted data, such as the program sequence module 402, the stage module 404, the intermediate state module 406, and/or the skip verify module 408. In various embodiments, the write module 306 may include all, some, or none of the depicted sub-modules. In one embodiment, the write module 306 is configured to use the program sequence module 402 to store the converted data to the array of cells. In a further embodiment, the program sequence module 402 may be configured to iteratively select cells for programming in a “programming sequence,” and program the selected cells, until the array of cells stores the converted data.

In one embodiment, each cell of the array of cells may encode an ordered sequence of states, and the program sequence module 402 may use the ordered sequence of states in a programming sequence. For example, in certain embodiments, a Flash memory cell may encode states in an ordered sequence from a lowest state to a highest state, according to the quantity of stored charge, or the threshold voltage for the cell. In some embodiments, a write module 306, non-volatile memory media controller 126, or the like may initialize Flash memory cells to the lowest state, referred to as the erased state, and program erased cells to higher states. In certain other embodiments a phase change memory cell may encode states in an ordered sequence from a lowest state to a highest state, according to the degree of crystallization or the electrical resistance for the cell. In some embodiments, the order for the ordered sequence of states may be a logical order defining a first, lowest, or erased state for the cell and successively higher states, with or without reference to the data-encoding physical property of the cell. For example, in one embodiment, where the data-encoding physical property of the cell is an electrical resistance, the highest state in the ordered sequence may have the lowest electrical resistance. In certain embodiments, therefore, descriptions of states as “first,” “last,” “previous,” “next,” “successive,” “lower,” “higher,” “lowest,” “highest,” or the like refer to a logical ordered sequence of states, which may or may not correspond to a physical order for the data-encoding physical property of the cell in various states. In some embodiments, the lowest state in the ordered sequence may be a state to which the write module 306, non-volatile memory media controller 126, or program sequence module 402 initializes each cell in the array of cells.

A “programming sequence” may refer to the order in which the program sequence module 402 selects and programs cells. In one embodiment, the program sequence module 402 may program the cells in a low-to-high programming sequence. In a “low-to-high” programming sequence, the program sequence module 402 may iteratively select cells that encode a data value other than a desired value from the converted data, and program the selected cells to a next state in the ordered sequence of states, until the converted data is stored. In some embodiments, a desired value from the converted data may be a digit in the target base, which the cell is to encode when the write module 306 writes the value to the cell. For example, in a first iteration, each cell may be initialized to the first state in the ordered sequence, which encodes a “0” in the target base, and the program sequence module 402 may select all the cells in the array of cells which are to encode a non-zero value, and program the selected cells to the second state in the ordered sequence, which encodes a “1” in the target base. In a second iteration, the program sequence module 402 may select all the cells in the array of cells which are to encode a value other than zero or one, and program the selected cells to the third state in the ordered sequence, which encodes a “2” in the target base. The program sequence module 402 may continue through subsequent iterations, selecting and programming cells to subsequently higher states, until each cell encodes its desired value and the converted data is stored. Another example of a low-to-high programming sequence is described below, with regard to FIG. 6.

In another embodiment, the program sequence module 402 may program the cells in a high-to-low programming sequence. In a “high-to-low” programming sequence, the program sequence module 402 may iteratively select cells for programming to a highest unprogrammed state in the ordered sequence of states, and program the selected cells to the highest unprogrammed state, until the converted data is stored. For example, in a first iteration, the program sequence module 402 may select all the cells in the array of cells which are to be programmed to the highest state in the ordered sequence, and program the selected cells to that state. In a second iteration, the program sequence module 402 may select all the cells in the array of cells which are to be programmed to the second highest state in the ordered sequence, and program the selected cells to that state. The program sequence module 402 may continue through subsequent iterations, selecting and programming cells to the highest unprogrammed state, until it reaches the lowest state, and the converted data is stored. Another example of a high-to-low programming sequence is described below, with regard to FIG. 7.

As compared to a low-to-high programming sequence, a high-to-low programming sequence may reduce disturb effects which may occur when the data-encoding physical property of one cell is inadvertently changed, or disturbed, as another cell, which may be physically near the first cell, is programmed to a higher level. However, a high-to-low programming sequence may also use more overall programming pulses than a low-to-high programming sequence to program all the cells in an array of cells such as a word line, or page. Although high-to-low and low-to-high programming sequences are specifically described herein, it is clear, in light of this disclosure that a program sequence module 402 may select and program cells in a variety of programming sequences, in various embodiments, to store the converted data.

In one embodiment, the write module 306 or the program sequence module 402 selects cells for programming using the stage module 404. In some embodiments, the stage module 404 is configured to mark bits associated with the selected cells in a write buffer for the array of cells. In a certain embodiment, a write buffer for an array of cells includes a bitmask, bitmap, or the like, with a number of bits corresponding to the number of cells, so that each bit in the write buffer has a corresponding cell in the array of cells. In one embodiment, the stage module 404 may mark bits in the write buffer that are associated with the selected cells by setting (e.g., writing a “1” to) the bits that correspond to the selected cells. In another embodiment the stage module 404 may mark bits in the write buffer that are associated with the selected cells by setting the bits for the non-selected cells. In further embodiments, the stage module 404 may mark bits in the write buffer that are associated with the selected cells by clearing (e.g., writing a “0” to) the bits for the selected cells, or by clearing the bits for the non-selected cells. In certain embodiments, the program sequence module 402 programs the selected cells in response to the stage module 404 marking bits associated with the selected cells in the write buffer, by issuing programming pulses to the cells with bits marked in the write buffer, and not to other cells in the array of cells. Using a stage module 404 to mark bits in a write buffer that correspond to selected cells in a programming sequence allows a write module 306 to use a binary write buffer infrastructure to store converted, non-binary data in the array of cells.

In one embodiment, the write module 306 or the program sequence module 402 may program one or more cells to an intermediate state in an ordered sequence of states using the intermediate state module 406. In some embodiments, the intermediate state module 406 is configured to change a programming level for a cell to a program value other than a target program value for the intermediate state. In certain embodiments, the write module 306, program sequence module 402, non-volatile memory media controller 126, or the like, may program a cell by changing a “programming level” (e.g., the data-encoding physical property of a cell) to a “program value.” For example, in one embodiment, the write module 306 may program a flash memory cell into the first state above the erased state by changing the threshold voltage Vₜ (e.g., the voltage sufficient to make the cell's transistor conduct when applied to the control gate) to one volt.

In some embodiments, the data-encoding physical property of a cell may drift from its originally programmed value over time due to disturb phenomena such as read disturbs, program disturbs, stress-induced leakage current, or the like, so the write module 306 may program a cell into a state by changing the programming level to a program value near the center of the range of values for the state. In further embodiments, the write module 306 may program a cell into a state by changing the programming level to a program value further from the center of the state, if the likely direction of disturb phenomena is known. For example, in one embodiment, if a the data-encoding physical property for a particular type of non-volatile memory media 122 tends to drift from higher values to lower values over time, the write module 306 may program a cell into a state by changing the programming level to a program value in the upper part of the range of values for the state.

In various embodiments, the “program value” may refer to the value to which the write module 306 actually changes the programming level when programming a cell, and the “target program value” may refer to the value to which the write module 306 would change the programming level when programming a cell, absent disturb phenomena. In certain embodiments, the intermediate state module 406 compensates for disturb phenomena by changing a programming level to a program value that differs from the target program value when programming a cell. For example, in one embodiment, if the write module 306 writes data to the cells using the program sequence module 402 with a low-to-high programming sequence, the physical value of cells programmed into intermediate states may drift upward in further iterations of the programming sequence, as the program sequence module 402 selects and programs other cells into higher states. In such an embodiment, the intermediate state module 406 may program a cell into an intermediate state by changing the cell's programming level to a program value which is lower than the target program value, so that each cell may drift toward the target program value during programming of other cells to higher states.

In one embodiment, the write module 306 or the program sequence module 402 may program one or more cells using the skip verify module 408. In certain embodiments, the skip verify module 408 is configured to store converted data to the array of cells by changing the programming level for at least one cell without verifying the change to the programming level. In some embodiments, if the write module 306 does not use a skip verify module 408, the write module 306 may program a cell by changing the programming level (e.g., the data-encoding physical property for the cell), then verify that the cell is in the desired state by checking the programming level. For example, the write module 306 may program a cell into a state by issuing a sequence of programming pulses, and attempting to verify, after each pulse, if the programming level for the cell has reached the desired program value for the state. However, in some embodiments, the response of each cell to various levels and widths of programming pulses is well characterized, and the write module 306 may use a skip verify module 408 to program a cell by issuing a sequence of programming pulses calculated to change the programming level for the cell to the desired program value, without verifying that the change to the programming level has occurred.

In one embodiment, the read module 410 is configured to read the converted, or non-binary data from the array of cells of the non-volatile memory media 122. In various embodiments, a means for reading the converted data may include a read module 410, a cell access module 150, a non-volatile memory controller 124, a non-volatile memory media controller 126, a read pipeline 241, other logic hardware, and/or other executable code stored on a computer readable storage medium. Other embodiments may include similar or equivalent means for reading data.

In one embodiment, the read module 410 may read the converted data by setting a plurality of read thresholds for the array of cells, and sensing cells that satisfy the read thresholds, until it determines a state for each cell in the array of cells. For example, in Flash memory, setting a read threshold may include applying a voltage to the control gates of several floating gate transistors in a word line, and sensing cells that satisfy the read threshold may include sensing which transistors have turned on in response to the applied voltage. In some embodiments, a cell may satisfy all, some, or none of the plurality of read thresholds, depending on the state of the cell. For example, a cell in the highest state in an ordered sequence of states may satisfy most or all of the read thresholds, while a cell in the lowest state may satisfy none of the read thresholds. Similarly, a cell in the first state above the lowest state may satisfy at least one read threshold, a cell in the next higher state may satisfy at least two of the read thresholds, and so on.

In some embodiments, the read module 410 sets a plurality of read thresholds including one read threshold at each boundary between successive states. In such an embodiment, the read module 410 senses which read thresholds each cell satisfies, and thereby determines a state for each cell. In a further embodiment, the read module 410 sets at least one additional read threshold in response to determining a state for each cell. In a certain embodiment, the read module 410 may sense cells that satisfy the additional read threshold(s). In further embodiments, the read module 410 may cooperate with the error module 418 to detect errors in the non-binary data using information derived from sensing cells that satisfy the additional read threshold(s).

In one embodiment, the read module 410 may set at least one additional read threshold with the same value as a read threshold from the original plurality of read thresholds. For example, in a further embodiment, the read module 410 may set a plurality of additional read thresholds at values matching the original read thresholds, so that the read module 410 may sense if cells satisfy the thresholds at a sampling frequency greater than or equal to twice the number of states per cell. Sensing if a cell satisfies the same read threshold value multiple times may generate soft data that the error module 418 may use with low-density parity check (“LDPC”) code decoders, or with other error correcting code (“ECC”) decoders that thrive on multiple reads for each state.

In another embodiment, the read module 410 may set at least one additional read threshold with a value between values of the original plurality of read thresholds. For example, in a further embodiment, the read module 410 may set the value of at least one additional read threshold within the range of values for a state, rather than at a boundary between states. Sensing if a cell satisfies one or more read thresholds within the range of values for a state may provide information indicating which direction the data-encoding physical property of a cell has drifted due to disturb phenomena. This information about disturbed cells may be useful for the read module 410 to set further read thresholds, or as soft data that the error module 418 may use with LDPC or other ECC decoders.

In one embodiment, the translate module 412 is configured to translate the converted, or non-binary data from the read module 410 to binary data. In various embodiments, a means for translating data may include a translate module 412, a cell access module 150, a non-volatile memory controller 124, a non-volatile memory media controller 126, a device driver such as a SML 130, a processor 111, a read pipeline 241, other logic hardware, and/or other executable code stored on a computer readable storage medium. Other embodiments may include similar or equivalent means for translating data.

In one embodiment, if the original data received by the interface module 302 was in binary form, the translate module 412 may perform the reverse operation of the base conversion module 304, to translate the converted data back to binary from the target base of the base conversion module 304. In another embodiment, the translate module 412 may use a base conversion algorithm to translate the converted data to binary data, whether or not the interface module 302 originally received the data in binary form. In various embodiments, the translate module 412 may use various base conversion algorithms, or similar methods, to translate the converted, or non-binary data to binary data. In light of this disclosure, many algorithms are clear which are suitable for use with a translate module 412.

In one embodiment, the return module 414 is configured to return the binary data from the translate module 412 to a host device, such as computing device 110, and/or to a storage controller for the non-volatile memory media 122, such as the SML 130, non-volatile memory media controller 126, or non-volatile memory controller 124. In various embodiments, a means for returning the binary data may include a return module 414, a cell access module 150, a non-volatile memory controller 124, a non-volatile memory media controller 126, a device driver such as a SML 130, a block I/O interface 131, a SML interface 132, a cache interface 133, a communication interface 113, a processor 111, a read pipeline 241, a system bus 125, a storage bus 127, other logic hardware, and/or other executable code stored on a computer readable storage medium. Other embodiments may include similar or equivalent means for returning data.

In some embodiments, the return module 414 returns binary data for convenient use and/or processing by a host computing device 110. In another embodiment, the return module 414 may return the binary data for comprehension by a local or remote storage client 116.

In one embodiment, the abode adjust module 416 is configured to dynamically adjust the number of abodes, or states per cell over time. In various embodiments, a means for dynamically adjusting the number of states per cell may include an abode adjust module 416, a cell access module 150, a non-volatile memory controller 124, a non-volatile memory media controller 126, a device driver such as a SML 130, a processor 111, other logic hardware, and/or other executable code stored on a computer readable storage medium. Other embodiments may include similar or equivalent means for dynamically adjusting the number of states per cell.

In a certain embodiment, a user of the non-volatile memory device 120 may use the abode adjust module 416 to adjust the number of abodes per cell to change an attribute of the non-volatile memory media 122 such as storage capacity, reliability, or the like. In a further embodiment, a user or manufacturer of a non-volatile memory device 120 may configure the abode adjust module 416 to adjust the number of abodes per cell based on one or more predetermined characteristics. For example, in one embodiment, the abode adjust module 416 may be configured to adjust the number of abodes per cell based on a health characteristic of the array of cells. In a further embodiment, the abode adjust module 416 may be configured to adjust the dynamic range for the data-encoding physical value of the cell over time, based on a health characteristic of the array of cells. A health characteristic may include age, number of program/erase cycles, error rate, or the like.

In general, disturb phenomena may have a greater effect on older, or more frequently used arrays of cells. If the stored value in a cell drifts too far from the originally programmed value due to disturb phenomena, the cell may drift into a different state. Error correcting algorithms can correct for some errors due to cells drifting into incorrect states, but these errors may also be reduced by increasing the size of each state, to make it less likely that a cell will drift into an adjacent state. In one embodiment, the abode adjust module 416 may increase the size of each state to increase the reliability of the array of cells, either by decreasing the number of states, or by increasing the size of the dynamic range that is divided into states. In another embodiment, disturb phenomena may be most pronounced for the highest states, where the data-encoding physical value is furthest from its ground state, and the abode adjust module 416 may increase the reliability of the array of cells by eliminating the highest state and reducing the dynamic range for the data-encoding physical value accordingly. In yet another embodiment, the abode adjust module 416 may increase the capacity of the array of cells by increasing the number of states per cell, at the expense of some reliability.

In one embodiment, the error module 418 is configured to use an error correcting algorithm to detect errors in the data received by the interface module 302, the converted data from the base conversion module 304, and/or the binary data from the translate module 412. In a further embodiment, the error module 418 may be configured to use an error correcting algorithm that operates on non-binary numbers to detect errors in the converted data from the base conversion module 304 (whether before writing by the write module 306, after reading by the read module 410, or at another time). In certain embodiments, the error module 418 may use LDPC or other ECC decoders in conjunction with the read module 410 to detect errors using information derived from sensing cells that satisfy read thresholds.

FIG. 5 depicts a further embodiment of a cell access module 150. The cell access module 150, in certain embodiments, may be substantially similar to the cell access module 150 described above with regard to FIGS. 1A, 1B, 2, 3, and/or 4. In the depicted embodiment, the cell access module 150 includes a write pipeline 240 and a read pipeline 241, which are communicatively coupled via a storage bus 127 to non-volatile memory media 122, including a plurality of non-volatile memory elements 123. In certain embodiments, the write pipeline 240, read pipeline 241, storage bus 127, non-volatile memory media 122, and non-volatile memory elements 123 may be substantially as described above with regard to FIGS. 1A, 1B, and/or 2.

In the depicted embodiment, the write pipeline 240 includes an interface module 302, a base conversion module 304, and a write module 306, which may be configured substantially as described above with regard to FIGS. 3 and/or 4. The read pipeline 241, in the depicted embodiment, includes a read module 410, a translate module 412, and a return module 414, which may be configured substantially as described above with regard to FIG. 4. The depicted embodiment is intended as illustrative and not limiting; non-depicted embodiments of the write pipeline 240 and/or the read pipeline 241 may include fewer modules than depicted or may include additional modules not described herein.

In one embodiment, the write pipeline 240 is configured to store data on the non-volatile memory media 122 using the interface module 302, the base conversion module 304, and the write module 306. As described above, in a certain embodiment, the interface module 302 may be configured to receive data for storage on the non-volatile memory media 122. In some embodiments, the non-volatile memory media 122 may include an array of cells, and each cell in the array may encode a non-power-of-two number of states per cell. In a further embodiment, the base conversion module 304 may be configured to convert the data to a non-base-two base corresponding to the non-power-of-two number of states per cell, so that the data has a non-binary alignment. In certain embodiments, the write module 306 may be configured to store the converted data to the array of cells so that the data has a non-binary alignment with regard to the cells.

In one embodiment, the read pipeline 241 is configured to read data from the non-volatile memory media 122 using the read module 410, the translate module 412, and the return module 414. As described above, in a certain embodiment, the read module 410 may be configured to read the converted data from the array of cells. In a further embodiment, the translate module 412 may be configured to translate the converted data to binary data. In some embodiments, the return module 414 may be configured to return the binary data to a host device, such as computing device 110, and/or to a storage controller for the non-volatile memory media 122, such as the SML 130, non-volatile memory media controller 126, or non-volatile memory controller 124. Thus, in the depicted embodiment, the read pipeline 241 may use the read module 410, the translate module 412, and the return module 414 to read data from the non-volatile memory media 122 by performing operations which are substantially the reverse of the operations performed by the write pipeline 240 to store data to the non-volatile memory media 122 using the interface module 302, the base conversion module 304, and the write module 306.

FIG. 6 depicts non-volatile cells 602a-e, at subsequent times 610, 620, 630, 640, 650 in one embodiment of a low-to-high programming sequence. In the depicted embodiment, each cell 602a-e encodes an ordered sequence of five states in order from L0 to L4. The states L0, L1, L2, L3, and L4 encode the base 5 digits “0,” “1,” “2,” “3,” and “4” respectively. Because each cell 602a-e, in the depicted embodiment, has five states or abodes (e.g., a non-power-of-two number of states) to encode base 5 digits, the cells 602a-e are non-binary aligned, and each cell 602a-e does not evenly encode a binary value. Thus, in one embodiment, data including the base 5 numeral “04213” is stored if cell 602a is in state L0, cell 602b is in state L4, cell 602c is in state L2, cell 602d is in state L1, and cell 602e is in state L3. In the depicted embodiment, the program sequence module 402 selects and programs cells 602a-e in a low-to-high programming sequence, as described above, to store the base 5 numeral “04213” with a non-binary alignment.

At time 610, before the first iteration of the program sequence module 402, each cell 602a-e is initialized to state L0. Each cell 602a-e encodes a “0,” so cell 602a encodes its desired value. Thus, in its first iteration, the program sequence module 402 selects the cells 602b-e for which the desired value is not “0,” and programs the selected cells 602b-e to the next state L1 in the ordered sequence. So, at time 620, after the first iteration of the program sequence module 402, cell 602a is in state L0 and cells 602b-e are in state L1.

At time 620, cells 602a and 602d encode their desired values of “0” and “1” respectively, so in its second iteration, the program sequence module 402 selects the remaining cells 602b,c,e, which do not yet encode their desired values, and programs the selected cells 602b,c,e to the next state L2 in the ordered sequence, as shown at time 630.

At time 630, after the second iteration of the program sequence module 402, cells 602a,c,d encode their desired values of “0,” “2,” and “1” respectively. So, in its third iteration, the program sequence module 402 selects the remaining cells 602b,e, which do not yet encode their desired values, and programs the selected cells 602b,e to the next state L3 in the ordered sequence, as shown at time 640.

At time 640, after the third iteration of the program sequence module 402, cells 602a,c-e encode their desired values of “0,” “2,” “1,” and “3” respectively. So, in its fourth iteration, the program sequence module 402 selects the remaining cell 602b, which does not yet encode its desired value, and programs the selected cell 602b to the next state L4 in the ordered sequence as shown at time 650. Thus, at time 650, after the fourth iteration of the program sequence module 402, cells 602a-e encode the desired values of “0,” “4,” “2,” “1,” and “3” respectively, and the base 5 numeral “02413” is stored, so the iterations of program sequence module 402 are at an end.

FIG. 7 depicts non-volatile cells 702a-e, at subsequent times 710, 720, 730, 740, 750 in one embodiment of a high-to-low programming sequence. In the depicted embodiment, each cell 702a-e encodes an ordered sequence of five states in order from L0 to L4. The states L0, L1, L2, L3, and L4 encode the base 5 numerals “0,” “1,” “2,” “3,” and “4” respectively. Thus, in one embodiment, data including the base 5 numeral “04213” is stored if cell 702a is in state L0, cell 702b is in state L4, cell 702c is in state L2, cell 702d is in state L1, and cell 702e is in state L3. In the depicted embodiment, the program sequence module 402 selects and programs cells 702a-e in a high-to-low programming sequence, as described above, to store the base 5 numeral “04213.”

At time 710, before the first iteration of the program sequence module 402, each cell 702a-e is initialized to the state L0. The highest unprogrammed state is state L4, so in its first iteration the program sequence module 402 selects cell 702b, which is to encode the digit “4,” and programs it to state L4, as shown at time 720.

At time 720, after the first iteration of the program sequence module 402, the highest unprogrammed state is state L3. So, in its second iteration, the program sequence module 402 selects cell 702e, which is to encode the digit “3,” and programs it to state L3, as shown at time 730.

At time 730, after the second iteration of the program sequence module 402, the highest unprogrammed state is state L2. So, in its second iteration, the program sequence module 402 selects cell 702c, which is to encode the digit “2,” and programs it to state L2, as shown at time 740.

At time 740, after the third iteration of the program sequence module 402, the highest unprogrammed state is state L1. So, in its fourth iteration, the program sequence module 402 selects cell 702d, which is to encode the digit “1,” and programs it to state L1, as shown at time 750. Thus, at time 750, after the fourth iteration of the program sequence module 402, cells 702a-e encode the desired values of “0,” “4,” “2,” “1,” and “3” respectively, and the base 5 numeral “02413” is stored, so the iterations of program sequence module 402 are at an end.

FIG. 8 depicts one embodiment of a method 800 for accessing non-volatile cells. The method 800 begins, and the interface module 302 receives 802 data for storage on non-volatile memory media 122. The non-volatile memory media 122 may include an array of cells, and each cell may encode a number of states per cell other than a power of two, so that the cells have a non-binary alignment. The base conversion module 304 converts 804 the data from a binary representation to a representation in a non-binary base using a number of unique digits equal to the number of states per cell. The write module 306 stores 806 the converted data to the array of cells with a non-binary alignment. The interface module 302 continues to receive 802 additional data, and the method 800 continues.

FIG. 9 depicts another embodiment of a method 900 for accessing non-volatile cells. The method 900 begins, and the interface module 302 receives 902 data for storage on non-volatile memory media 122. The non-volatile memory media 122 may include an array of cells, and each cell may encode a number of states per cell other than a power of two, may have a non-binary alignment, or the like. The base conversion module 304 converts 904 the data from a binary representation to a representation in a non-binary base using a number of unique digits equal to the number of states per cell. The method 900 enters a loop, and the program sequence module 402 selects 906 cells for programming that encode a data value other than a desired value from the converted data. The program sequence module 402 programs 908 the selected cells to the next state in an ordered sequence, and determines 910 if the array of cells stores the converted data. If the converted data is not stored, the method 900 returns to the start of the loop, where the program sequence module 402 again selects 906 cells for programming, and continues as before.

If the converted data is stored, the method 900 exits the loop, and the read module 410 reads 912 the converted data from the array of cells. The translate module 412 translates 914 the converted data to binary data. The return module 414 returns 916 the binary data to a host device, such as computing device 110, and/or to a storage controller for the non-volatile memory media 122, such as the SML 130, non-volatile memory media controller 126, or non-volatile memory controller 124, and the method 900 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method comprising:
receiving data for storage on a non-volatile recording medium, the non-volatile recording medium comprising an array of cells, each cell encoding a number of states per cell;
converting the data from a binary representation to a non-binary representation corresponding to the number of states per cell; and
storing the converted data to the array of cells.

2. The method of claim 1, wherein each cell of the array of cells encodes an ordered sequence of states, and storing the converted data to the array of cells comprises iteratively selecting cells that encode a data value other than a desired value from the converted data, and programming the selected cells to a next state in the ordered sequence of states, until the converted data is stored.

3. The method of claim 2, wherein selecting cells comprises marking bits associated with the selected cells in a write buffer for the array of cells.

4. The method of claim 2, wherein programming a cell to an intermediate state in the ordered sequence of states comprises changing a programming level for the cell to a program value other than a target program value for the intermediate state.

5. The method of claim 1, wherein storing the converted data to the array of cells comprises changing a programming level for at least one cell without verifying the change to the programming level.

6. The method of claim 1, wherein each cell of the array of cells encodes an ordered sequence of states, and storing the converted data to the array of cells comprises iteratively selecting cells for programming to a highest unprogrammed state in the ordered sequence of states, and programming the selected cells, until the converted data is stored.

7. The method of claim 1, further comprising:
reading the converted data from the array of cells;
translating the converted data to binary data; and
returning the binary data to one or more of a host device and a storage controller for the non-volatile recording medium.

8. The method of claim 7, wherein reading the converted data from the array of cells comprises setting a plurality of read thresholds for the array of cells and sensing cells that satisfy the read thresholds, until a state is determined for each cell in the array of cells.

9. The method of claim 8, wherein reading the converted data further comprises:
setting at least one additional read threshold in response to determining a state for each cell;
sensing cells that satisfy the at least one additional read threshold; and
detecting errors in the converted data using information derived from sensing cells that satisfy the at least one additional read threshold.

10. The method of claim 1, further comprising dynamically adjusting the number of states per cell over time.

11. The method of claim 10, wherein the number of states per cell is adjusted based on a health characteristic of the array of cells.

12. The method of claim 1, further comprising using an error correcting algorithm that operates on non-binary numbers to detect errors in the converted data.

13. An apparatus comprising:
an interface module configured to receive data for storage on a non-volatile memory medium, the non-volatile memory medium comprising an array of cells, each cell encoding a number of abodes per cell with a non-binary alignment;
a base conversion module configured to convert the data from a binary representation to a representation in a non-binary base, the non-binary base using a number of unique digits equal to the non-binary aligned number of abodes per cell; and
a write module configured to store the converted data to the array of cells.

14. The apparatus of claim 13, wherein each cell of the array of cells encodes an ordered sequence of abodes, and the write module is configured to store the converted data to the array of cells by iteratively selecting cells that encode a data value other than a desired value from the converted data, and programming the selected cells to a next abode in the ordered sequence of abodes, until the converted data is stored.

15. The apparatus of claim 13, wherein each cell of the array of cells encodes an ordered sequence of abodes, and the write module is configured to store the converted data to the array of cells by iteratively selecting cells for programming to a highest unprogrammed abode in the ordered sequence of abodes, and programming the selected cells, until the converted data is stored.

16. The apparatus of claim 13, wherein the base conversion module is further configured to separate a binary stream for the data into a plurality of binary numbers and to convert each binary number to the non-binary base, each binary number comprising a number of bits less than or equal to a word unit size for the array of cells.

17. The apparatus of claim 13, further comprising:
a read module configured to read the converted data from the array of cells;
a translate module configured to translate the converted data to binary data; and
a return module configured to return the binary data to one or more of a host device and a storage controller for the non-volatile memory medium.

18. The apparatus of claim 13, further comprising an abode adjust module configured to dynamically adjust the number of abodes per cell over time based on a health characteristic of the array of cells.

19. The apparatus of claim 13, further comprising an error module configured to use an error correcting algorithm that operates on non-binary numbers to detect errors in the converted data.

20. An apparatus comprising:
means for receiving data for storage on a non-volatile storage medium, the non-volatile storage medium comprising an array of cells, each cell encoding a non-power-of-two number of encoding states per cell;
means for converting the data from a binary representation to a representation in a non-binary base, the non-binary base using a number of unique digits equal to the number of encoding states per cell for storage by the non-volatile storage medium; and
means for dynamically adjusting the number of states per cell over time.

21. The apparatus of claim 20, further comprising:
means for storing the converted data to the array of cells;
means for reading the converted data from the array of cells;
means for translating the converted data to binary data; and
means for returning the binary data to one or more of a host device and a storage controller for the non-volatile storage medium.

22. A system comprising:
a non-volatile recording device comprising a non-volatile recording medium, the non-volatile recording medium comprising an array of cells, each cell encoding a non-power-of-two number of states per cell, the non-volatile recording device in communication with a host device over a communications bus; and
a write pipeline comprising,
an interface module configured to receive data for storage on the non-volatile recording medium;
a base conversion module configured to convert the data from a binary representation to a representation in a non-base-two base, the non-base-two base using a number of unique digits equal to the non-power-of-two number of states per cell; and
a write module configured to store the converted data to the array of cells.

23. The system of claim 22, further comprising a read pipeline, the read pipeline comprising:
a read module configured to read the converted data from the array of cells;
a translate module configured to translate the converted data to binary data; and
a return module configured to return the binary data to one or more of a host device and a storage controller for the non-volatile recording medium.

24. A computer program product comprising a computer readable storage medium storing computer usable program code executable to perform operations, the operations comprising:
reading non-binary data from a non-volatile memory medium, the non-volatile memory medium comprising an array of cells, each cell encoding a number of abodes per cell other than a power of two, the non-binary data encoded in a non-binary base, the non-binary base using a number of unique digits equal to the number of abodes per cell;
translating the non-binary data to binary data; and
returning the binary data to one or more of a host device and a storage controller for the non-volatile memory medium.

25. The computer program product of claim 24, wherein reading the non-binary data from the non-volatile memory medium comprises:
setting a plurality of read thresholds for the array of cells;
sensing cells that satisfy the read thresholds, until an abode is determined for each cell in the array of cells;
setting at least one additional read threshold in response to determining am abode for each cell;
sensing cells that satisfy the at least one additional read threshold; and
detecting errors in the non-binary data using information derived from sensing cells that satisfy the at least one additional read threshold.
